(19) United States
(12) Patent Application Publication
(10) Pub. No.: US 2007/0111313 A1
(43) Pub. Date: May 17, 2007

(54) Hydrogen-sensitive coating for hydrogen detection

(76) Inventor: George Saloka, Dearborn, MI (US)

Correspondence Address: TUNG & ASSOCIATES, 838 WEST LONG LAKE, SUITE 120, BLOOMFIELD HILLS, MI, 48302, US

(21) Appl. No.: 11/281,216

(22) Filed: Nov. 16, 2005

(51) Int. Cl. G01N 31/00

(52) U.S. Cl. 436/2

(57) ABSTRACT

Use of a hydrogen-sensitive coating as a hydrogen detector is disclosed. The invention includes providing a hydrogen-sensitive coating on a surface to detect the presence of hydrogen in the vicinity of the surface. A fuel cell system having a hydrogen-sensitive coating is also disclosed.

### FIELD OF THE INVENTION

The present invention relates to hydrogen detectors. More particularly, the present invention relates to the use of hydrogen-sensitive surface coatings to detect hydrogen in the vicinity of a vehicular fuel cell, hydrogen-fueled internal combustion engine or other system.

### BACKGROUND OF THE INVENTION

Fuel cell technology potentially provides clean and efficient energy for stationary and traction applications. A functioning fuel cell, as any other electrochemical device, requires a series of components that provide the key functions of reactant distribution (mass transport), catalytic reactivity, ionic separation, and current collection. A typical fuel cell system includes a fuel cell stack which includes multiple fuel cells arranged in a stacked configuration for the generation of electrical power. A hydrogen distribution line connects a hydrogen storage tank to the fuel cell stack. At least one regulator is typically provided in the hydrogen distribution line for controlling the distribution of gaseous hydrogen from the hydrogen storage tank to the fuel cell stack.

Presently, the state of the art for hydrogen detection control in fuel cell and other systems falls into two categories: (1) active hydrogen sensors and (2) reliance on the structural integrity of the system. Active hydrogen sensors function only when DC power is applied and may lose sensitivity over time. Generally, the fluid integrity a hydrogen gas distribution system is checked after initial installation by running helium through the system.

A passive hydrogen detection system which includes the use of a hydrogen-sensitive coating is needed for fuel cell and other systems.

### SUMMARY OF THE INVENTION

The present invention is generally directed to use of a hydrogen-sensitive coating as a hydrogen detector. According to the invention, a hydrogen-sensitive coating is provided on a surface to detect the presence of hydrogen in the vicinity of the surface. The present invention is further directed to a fuel cell system having a hydrogen-sensitive coating.

### BRIEF DESCRIPTION OF THE DRAWINGS

The invention will now be described, by way of example, with reference to the accompanying drawings, in which:

FIG. 1 is a schematic view of an illustrative fuel cell system in implementation of the present invention;

FIG. 2 is a sectional view of a hydrogen storage tank, a line fitting extending from the tank and a hydrogen distribution line connected to the line fitting, with a hydrogen-sensitive coating provided on the tank, the line fitting and the hydrogen distribution line in implementation of the present invention;

FIG. 3 is a sectional view of a regulator provided in the hydrogen distribution line, with a hydrogen-sensitive coating provided on the regulator housing, line fittings and hydrogen distribution line in implementation of the present invention;

FIG. 4 is a sectional view of a portion of a fuel cell stack of the fuel cell system, with a hydrogen-sensitive coating provided on the hydrogen distribution line, hydrogen inlet fitting and wall of the fuel cell stack in implementation of the present invention;

FIG. 4A is a cross-sectional view of a surface, illustrating a hydrogen-sensitive coating embedded in the surface according to an alternative implementation of the invention; and

FIG. 5 is a top view of a section of a hydrogen distribution line, with a hydrogen-sensitive coating provided on the hydrogen distribution line, more particularly illustrating a bright-colored region of the hydrogen-sensitive coating compared to the surrounding regions of the coating as indicative of the presence of hydrogen gas.

### DETAILED DESCRIPTION OF THE INVENTION

The present invention is generally directed to the use of a hydrogen-sensitive coating as a hydrogen detector in a fuel cell system. However, it is to be understood that the invention is not to be limited to use in fuel cell systems but is intended to include use in any system, application or industry in which hydrogen is stored, transported and otherwise used.

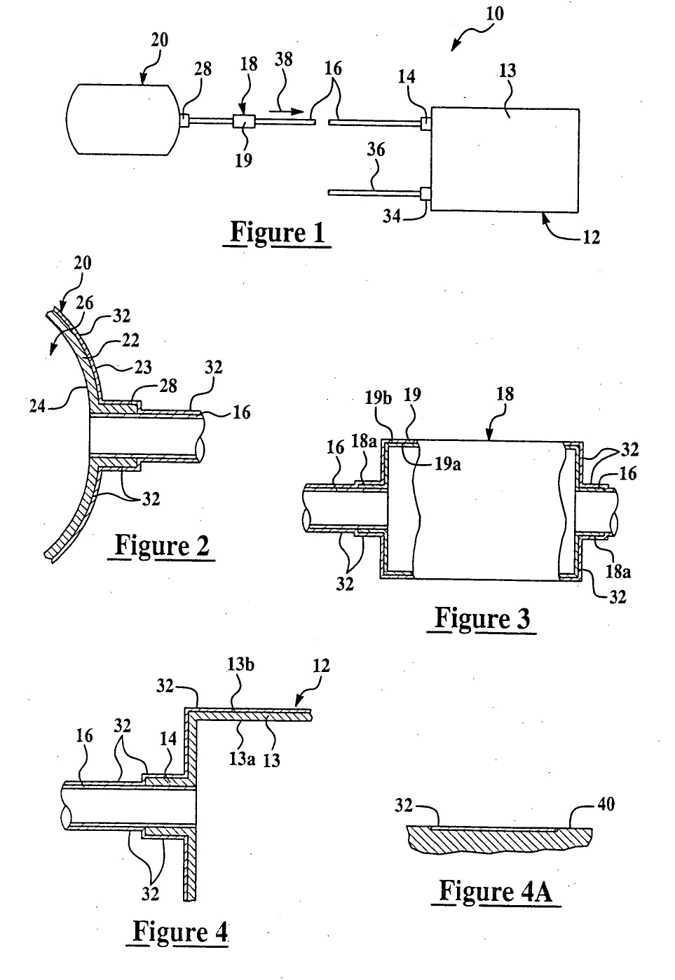

Referring to the drawings, an illustrative fuel cell system in implementation of the present invention is generally indicated by reference numeral 10 in FIG. 1. In accordance with the present invention, various components of the fuel cell system 10 are coated with a hydrogen-sensitive coating 32, as shown in FIGS. 2-4 and will be hereinafter further described. Generally, the fuel cell system 10 includes a fuel cell stack 12 which is connected to a hydrogen storage tank 20 through a hydrogen distribution line 16. The fuel cell stack 12 includes a fuel cell enclosure 13 which includes an interior surface 13a and an exterior surface 13b, as shown in FIG. 4. Multiple fuel cells (not shown), which are electrically connected to each other in a stacked configuration, are contained inside the fuel cell enclosure 13.

A hydrogen inlet fitting 14 is provided on the fuel cell enclosure 13 to facilitate attachment of the hydrogen distribution line 16 to the fuel cell stack 12. An oxidant gas inlet 34 is further provided on the fuel cell enclosure 13 to facilitate attachment of an oxidant gas distribution line 36 to the fuel cell stack 12. At least one regulator 18 is typically provided in the hydrogen distribution line 16 to regulate the flow of hydrogen gas 38 from the hydrogen storage tank 20, through the hydrogen distribution line 16 and to the fuel cell stack 12. As shown in FIG. 3, the regulator 18 typically includes a regulator housing 19 which contains the functional regulator elements (not shown) of the regulator 18. The regulator housing 19 includes an interior surface 19a and an exterior surface 19b. A pair of line fittings 18a may extend from opposite ends of the regulator housing 19 and each receives a corresponding segment of the hydrogen distribution line 16.

As shown in FIG. 2, the hydrogen storage tank 20 typically includes a tank wall 22 which has an exterior surface 23 and an interior surface 24 and encloses a tank interior 26. A line fitting 28 extends from the tank wall 22 and is connected to the hydrogen distribution line 16. Accordingly, in operation of the fuel cell system 10, hydrogen gas 38 is distributed from the hydrogen storage tank 20 through the line fitting 28, the hydrogen distribution line 16, the regulator or regulators 18 and the hydrogen inlet fitting 14 and into the fuel cell stack 12, respectively.

According to the present invention, a hydrogen-sensitive coating 32 is applied to the exterior surfaces of various components of the fuel cell system 10. These may include, for example, the exterior surface 23 of the hydrogen storage tank 20 and/or the exterior surfaces of the line fitting 28; the hydrogen distribution line 16; the regulator and/or regulators 18; the hydrogen inlet fitting 14; and/or the fuel cell enclosure 13, respectively. The hydrogen-sensitive coating 32 may be any type of pressure-sensitive coating or material which is known to those skilled in the art and utilizes luminescence to indicate static pressure on a surface. The pressure-sensitive coating indicates differences in atmospheric pressure on the surface by indicating a slight change in color in areas subjected to a high partial pressure of oxygen relative to the color of the coating on the adjacent areas subjected to low partial pressures of oxygen. The intensity of the color is proportional to the magnitude of the partial pressure of oxygen applied to the coating. In the event hydrogen is present, the hydrogen displaces the oxygen and changes the luminosity of the coating. The invention is also applicable to hydrogen-sensitive coatings which indicate a change upon reacting chemically with hydrogen.

An example of a pressure-sensitive material which is suitable for carrying out the present invention is a pressure-sensitive paint (PSP) such as ISSI UNICOAT (trademark) available from ISSI (Innovative Scientific Solutions, Inc). However, it is to be understood that the invention may be carried out using any type of pressure-sensitive paint or other pressure-sensitive coating or material which is suitable for sensing the presence of hydrogen typically by increased hydrogen gas pressure. Preferably, the pressure-sensitive coating is of the type in which variations in brightness, intensity or darkness which are observed by the naked eye represent corresponding variations in gas pressure on the coating, with the brighter, more intense or darker areas representing the areas of higher hydrogen pressure than the surrounding areas. It has been found that PSP, when sealed in a Pyrex® flask, maintains a dull, flat grayish tone, when viewed through a color filter, during exposure to ambient air but changes to a bright orange hue upon exposure to hydrogen. Therefore, when PSP is used to coat a surface, the region or regions of hydrogen presence would be indicated by the presence of a bright orange spot or spots on the otherwise gray PSP when viewed through a color filter. However, the invention is also applicable to hydrogen-sensitive coatings which change color or intensity without the necessity of being viewed through a color filter.

As shown in FIG. 2, according to the present invention, the hydrogen-sensitive coating 32 may be coated on the exterior surface 23 of the tank wall 22, the line fitting 28, and/or the hydrogen distribution line 16. As shown in FIG. 3, the hydrogen-sensitive coating 32 may additionally or alternatively be coated on the exterior surface 19b of the regulator housing 19 and/or the line fittings 18a of the regulator housing 19. As shown in FIG. 4, the hydrogen-sensitive coating 32 may additionally or alternatively be applied to the exterior surface 13b and/or the hydrogen inlet fitting 14 of the fuel cell enclosure 13. Preferably, however, the hydrogen-sensitive coating 32 is coated as a continuous layer on the exterior surface 23 and line fitting 28 of the hydrogen storage tank 20; the hydrogen distribution line 16; the line fittings 18a and exterior surface 19b of the regulator housing 19; and the hydrogen inlet fitting 14 and the exterior surface 13b of the fuel cell enclosure 13.

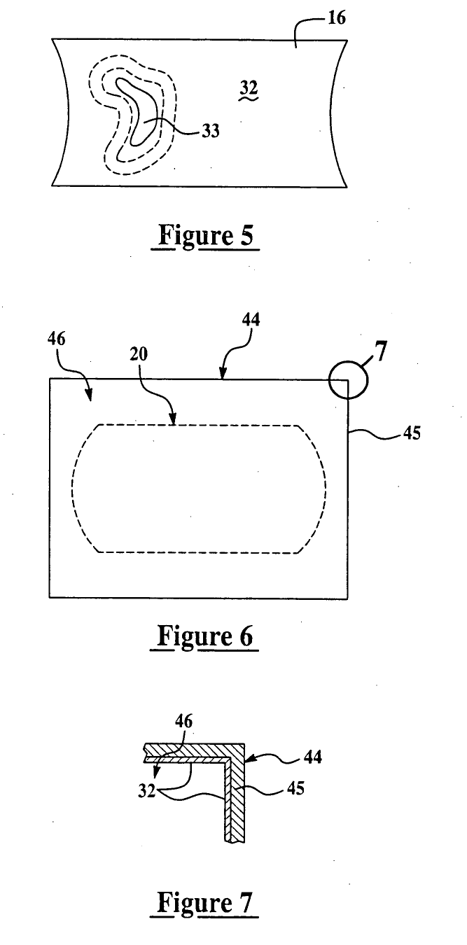

As shown in FIG. 5, in the event that hydrogen gas pressures from the hydrogen distribution line 16 are not normal, for example, during operation of the fuel cell system 10, the hydrogen sensitive coating 32 indicates the location of the hydrogen by the presence of a bright or dark region 33, at a point where the hydrogen is present, relative to the surrounding regions of the hydrogen-sensitive coating 32. In like manner, the hydrogen-sensitive coating 32 indicates the presence of hydrogen from the fuel cell system 10 at the tank wall 22, the line fitting 28, the regulator housing 19, the line fitting 18a, the hydrogen inlet fitting 14 and/or the fuel cell enclosure 13.

An alternative application of the invention is shown in FIG. 4A, in which the hydrogen-sensitive coating 32, rather than being applied to an exterior surface, as was heretofore described with respect to FIGS. 2-4, is embedded in a surface 40. The surface 40 may be, for example, the exterior surface 23 of the tank wall 22 of the hydrogen storage tank 20; the exterior surface of the line fitting 28; the exterior surface of the hydrogen distribution line 16; the exterior surface of the regulator housing 19; the exterior surface of the hydrogen inlet fitting 14; and/or the exterior surface 13b of the fuel cell enclosure 13 of the fuel cell system 10 which was heretofore described with respect to FIGS. 1-4. Alternatively, the surface 40 may be on a component in any system, application or industry in which hydrogen is stored, transported or otherwise used. Accordingly, the embedded hydrogen-sensitive coating 32 is suitable for detecting the presence of hydrogen in and/or around the surface 40 typically in the manner which was heretofore described with respect to FIG. 5.

Referring next to FIGS. 6 and 7, in many fuel cell applications, the hydrogen storage tank 20 is contained inside a hydrogen storage tank box 44 for aesthetic purposes to normally conceal the hydrogen storage tank 20 from view. The hydrogen storage tank box 44 includes a box wall 45 which defines a box interior 46. As shown in FIG. 7, a hydrogen-sensitive coating 32 is provided on at least one interior surface of the box wall 45. Therefore, in the event of the presence of hydrogen in the hydrogen storage tank 20, the hydrogen-sensitive coating 32 indicates the presence of hydrogen in the box interior 46 of the hydrogen storage tank box 44 when the hydrogen storage tank box 44 is opened.

While the preferred embodiments of the invention have been described above, it will be recognized and understood that various modifications can be made in the invention and the appended claims are intended to cover all such modifications which may fall within the spirit and scope of the invention.

What is claimed is:

1. A method of detecting hydrogen on a surface, comprising:
providing a hydrogen-sensitive coating on said surface; and
detecting hydrogen on said surface by a change in appearance of said hydrogen-sensitive coating.

2. The method of claim 1 wherein said providing a hydrogen-sensitive coating on said surface comprises embedding said hydrogen-sensitive coating in said surface.

3. The method of claim 1 wherein said hydrogen-sensitive coating comprises a pressure-sensitive paint.

4. The method of claim 1 wherein said surface comprises a surface on a fuel cell system.

5. The method of claim 4 wherein said surface comprises an exterior surface on a hydrogen storage tank.

6. The method of claim 4 wherein said surface comprises an exterior surface of a line fitting on a hydrogen storage tank.

7. The method of claim 4 wherein said surface comprises an exterior surface of a hydrogen distribution line.

8. The method of claim 4 wherein said surface comprises an exterior surface on a regulator housing of a regulator.

9. The method of claim 4 wherein said surface comprises at least one of an exterior surface of a hydrogen inlet fitting on a fuel cell enclosure and an exterior surface of a fuel cell enclosure.

10. A method of detecting hydrogen in a fuel cell system having a plurality of exterior surfaces, comprising:
providing a hydrogen-sensitive coating on at least one of said plurality of exterior surfaces; and
detecting hydrogen on at least one of said plurality of exterior surfaces by a change in appearance of said hydrogen-sensitive coating.

11. The method of claim 10 wherein said providing a hydrogen-sensitive coating on at least one of said plurality of exterior surfaces comprises providing a hydrogen-sensitive coating on all of said plurality of exterior surfaces.

12. The method of claim 10 wherein said hydrogen-sensitive coating comprises a pressure-sensitive paint.

13. The method of claim 10 wherein said providing a hydrogen-sensitive coating on at least one of said plurality of surfaces comprises embedding said hydrogen-sensitive coating in at least one of said plurality of surfaces.

14. The method of claim 10 wherein said providing a hydrogen-sensitive coating on at least one of said plurality of exterior surfaces comprises providing said hydrogen-sensitive coating on at least one of an exterior surface of a hydrogen storage tank and a line fitting extending from said hydrogen storage tank.

15. The method of claim 14 further comprising providing said hydrogen-sensitive coating on a hydrogen distribution line extending from said line fitting.

16. The method of claim 10 wherein said providing a hydrogen-sensitive coating on at least one of said plurality of exterior surfaces comprises providing said hydrogen-sensitive coating on an exterior surface of at least one of a hydrogen storage tank, a line fitting extending from said hydrogen storage tank, a hydrogen distribution line extending from said line fitting, a regulator provided in said hydrogen distribution line, a hydrogen inlet fitting connected to said hydrogen distribution line, and a fuel cell enclosure connected to said hydrogen inlet fitting.

17. A fuel cell system comprising:
a hydrogen storage tank;
a hydrogen distribution line connected to said hydrogen storage tank;
a fuel cell stack connected to said hydrogen distribution line;
at least one regulator provided in said hydrogen distribution line; and
a hydrogen-sensitive coating provided on an exterior surface of at least one of said hydrogen storage tank, said hydrogen distribution line, said fuel cell stack and said at least one regulator.

18. The fuel cell system of claim 17 wherein said hydrogen-sensitive coating comprises a pressure-sensitive paint.

19. The fuel cell system of claim 17 wherein said hydrogen-sensitive coating is provided on said hydrogen storage tank, said hydrogen distribution line, said fuel cell stack and said at least one regulator.

20. The fuel cell system of claim 17 further comprising at least one fitting connected to said hydrogen distribution line and wherein said hydrogen-sensitive coating is provided on said at least one fitting.
